(19) United States
(12) Patent Application Publication
(10) Pub. No.: US 2018/0343827 A1
(43) Pub. Date: Dec. 6, 2018

(54) DEVICE FOR THROWING FEED AND APPARATUS FOR SUPPLYING FEED USING THE SAME

(71) Applicant: YOUNG JUN HONG, Goyang-si (KR)

(72) Inventor: YOUNG JUN HONG, Goyang-si (KR)

(21) Appl. No.: 15/963,291

(22) Filed: Apr. 26, 2018

(30) Foreign Application Priority Data
May 30, 2017 (KR) 10-2017-0067127

(51) Int. Cl. A01K 5/02

(52) U.S. Cl. CPC A01K 5/02

(57) ABSTRACT

The present invention relates to a device for throwing a feed having the form of a pellet to supply the feed to a pet and a device for supplying a feed using the same. The device for throwing the feed includes: a throw part comprising a throw arm rotating within a limited angle and a throw container coupled to the throw arm to allow the pellet feed to be seated thereon; a fixing support part coupled to a rotational center of the throw arm to fix the throw part; and an elastic driving part rotating between a seating position at which the feed is seated and a throwing position at which the feed is thrown. Therefore, the pet may feel the fun and eat the feed, the feed may be regularly supplied even when the user is absent, and the quantity of exercise of the pet may be improved.

### TECHNICAL FIELD

The present invention relates to a device for throwing a feed having the form of a pellet to supply the feed to a pet and an apparatus for supplying a feed, which supplies the feed to the pet, using the same.

### BACKGROUND ART

Recently, there are more households that have pets for small households such as single-person households and two-person households and for the purpose of raising the emissions of children.

In order to keep such a pet healthy, continuous management is necessary. In particularly, in the case of feeding, it is necessary to feed a fixed amount of feeds at a certain time to prevent problems such as obesity due to malnutrition or overeating.

However, there are cases in which the feeds are not regularly supplied to the pet due to a long-term outing and the like. As a result, there is a drawback in that the pet eats the feeds in a hurry. Also, if a large amount of feeds is supplied at a time when going out for a long time, there is a problem that the pet suffer health problems due to ingestion of the feeds at once or altered feeds.

In order to solve such a problem, Korean Patent Publication No. 10-2016-0081468 discloses an intelligent feed supply apparatus for a pet, which automatically supplies pet's feeds by a set amount at a set time interval even when the owner of the companion animal empties the house.

However, in the case of the above-described technique according to the related art, even if the owner goes out, it is possible to feed the feeds to the pet, but the pet swallows the foods without chewing, resulting in health problems such as poor digestion. Also, there is a problem that the physical strength of the pet is lowered because the pet has a less moving amount due to the absence of the owner, and there is a problem that the pet is separated from the owner and thus feels psychological instability.

U.S Patent Publication No. 14-205434 according to the related art discloses an apparatus for launching a feed, which hits the feed by using a pusher after the feed is mounted on a specific position to launch the feed to be supplied.

However, the feed may be damaged while the feed is hit, and since the user directly adjusts a launching position while the user grips the apparatus for launching the feed by using a hand thereof, it is difficult to launch the feed at an adequate position, and there is a risk of launching the feed toward the pet if the user is mistaken.

U.S Patent Publication No. 14-997007 according to the related art discloses a feed supply apparatus in which pellets of feeds are pushed to be discharged from a feed storage box by using a first pusher, and the discharged feeds are hit and launched by a second pusher to launch and supply the pellet feeds.

However, when the feed is properly seated on an upper portion of the first pusher, a problem that the feed is not discharged even when the first pusher ascends frequently occurs, the feed is damaged while hitting the discharged feed by the second pusher, and there is difficult to improve a quantity of exercise of the pet through falling of the launched feed to a certain position.

### DISCLOSURE OF THE INVENTION

### Technical Problem

Also, to solve the above-described background art, an object of the present invention is to provide a device for throwing a feed, which regularly supplies feeds even when a user is not present to improve a quantity of exercise of a pet, and an apparatus for supplying a feed using the same.

Also, an object of the present invention is to provide a device for throwing a feed, which supplies the feed in the form of a pellet to help digestion of the pet, and an apparatus for supplying a feed using the same.

### Technical Solution

A device for throwing a feed according to the present invention for solving the above-described object includes: a throw part including a throw arm rotating within a limited angle and a throw container coupled to the throw arm to allow the pellet feed to be seated thereon; a fixing support part coupled to a rotational center of the throw arm to fix the throw part; and an elastic driving part rotating between a seating position at which the feed is seated and a throwing position at which the feed is thrown.

Preferably, the elastic driving part may include: an elastic member made of an elastic material and having one side connected to the throw arm; a rotation drum which is connected to the other side of the elastic member and around which the elastic member is wound; and a rotation driving source rotating the rotation drum to provide an elastic force to the elastic member.

Preferably, the device may further include a controller controlling the rotation driving source to adjust a rotation amount of rotation drum so that a drawing distance of the feed is adjusted.

Preferably, the device may further includes a hook part including a hook member fixing the throw arm at the seating position or releasing the fixed state so that the throw arm rotates from the seating position to the throwing position and a hook driving part driving the hook member.

Preferably, the device may further include a stopper restricting a rotation angle of the throw arm to set a throwing angle of the feed at the throwing position.

Preferably, in the stopper, the throw arm may be disposed to be inclined at an angle of 15° to 60° with respect to a horizontal plane at the throwing position.

Preferably, the device may further include a stopper moving part adjusting an arrangement position of the stopper to adjust a throwing angle of the feed.

Preferably, the throw container may have a discharge hole, through which feed powder generated from the feed is discharged, in a bottom surface on which the feed is seated.

Preferably, the device may further include a feed powder accommodation part detachably disposed on a lower portion of the throw container to accommodate the feed powder.

Preferably, the device may further include a rotation driving device rotating the device for throwing the feed with respect to an axis perpendicular to a horizontal plane to adjust a throwing direction of the throw part.

Preferably, the rotation driving device may tilt the device for throwing the feed with respect to the horizontal plane.

Preferably, the rotation driving device may include: a base on which the device for throwing the feed is seated on an upper portion thereof; and a base driving part rotatably driving the base.

An apparatus for supplying a feed according to the present invention for solving the above-described another object includes: the above-described device for throwing the feed; a rotation driving device rotating the device for throwing the feed with respect to an axis perpendicular to a horizontal plane to adjust a throwing direction of the throw part; a camera part rotatably driven by the rotation driving device to obtain an image in a direction in which the feed is thrown; a wired or wireless communication part that transmits the image information to a user terminal and receives a throwing operation signal including at least one of a throwing direction signal, a throwing distance signal, and a throwing start signal from the user terminal; and a controller controlling operations of the device for throwing the feed and the rotation driving device according to the throwing operation signal received from the communication part.

An apparatus for supplying a feed, which throws the feed having the form of a pellet, according to the present invention for solving the above-described further another object includes: the above-described device for throwing the feed; and a device for supplying a pellet, which supplies the pellet feed to the throw container.

Preferably, the device for throwing the feed may receive the set number of feeds, i.e., two or more feeds from the device for supplying the pellet to throw the feeds at the same time.

Preferably, the device for supplying the pellet may include: a body part having a fixed hole, through which the feed is discharged, in a bottom surface of an inner space in which the feed is stored; a rotation plate part disposed in the inner space and having one or more rotation holes, the rotation plate part rotating so that, when the rotation holes rotate, the feed seated in each of the rotation holes is discharged through the fixed hole from a discharge position at which the rotation hole and the fixed hole meet each other; and a rotation plate driving part rotating the rotation plate part, wherein the apparatus may further include a guide part guiding the feed discharged through the fixed hole so that the feed is seated on the throw container.

Preferably, the apparatus may further include a separation prevention plate disposed at a side portion of the throw container to prevent the feed supplied to the throw container from being separated to the outside of the apparatus for supplying the feed.

Preferably, the apparatus may further include a sound source generation part generating a sound source before the feed seated on the throw container is thrown.

Preferably, the sound source generation part may generate the sound source between a throwing time point of the feed and a falling time point of the feed.

### Advantageous Effects

In the device for throwing the feed and the apparatus for supplying the feed using the same according to the present invention, since the feed is thrown to be supplied, the pet may feel the fun and eat the feed, the feed may be regularly supplied even when the user is absent, and the quantity of exercise of the pet may be improved.

Also, according to the present invention, the throw container on which the feed is seated may rotate to throw the feed. Thus, when the feed is thrown, the impact may not occur to prevent the feed from being damaged.

Also, according to the present invention, the elastic driving part may be provided to adjust the elastic force for throwing the feed, thereby adjusting the throwing distance of the feed.

Also, according to the present invention, the throwing angle of the feed may be adjusted so that the pet recognizes the thrown feed to eat the feed or find and eat the feed.

Also, according to the present invention, when the thrown feed falls, the rolling of the feed may be prevented, and the flying time of the feed may increase so that the pet is capable of recognizing the flying feed.

Also, according to the present invention, the discharge hole and the feed powder accommodation part may be provided to prevent the feed from being thrown together with the feed powder and easily clean the feed powder.

Also, according to the present invention, the rotation driving device may be provided to adjust the throwing direction of the feed.

Also, according to the present invention, the user may commune with the pet through the user terminal to reduce the psychological anxiety of the pet.

Also, according to the present invention, the device for supplying the pellet may be provided to automatically supply the plurality of pellet feeds in the form of the pellet.

Also, according to the present invention, the pellet feed may be thrown so that the pet sufficiently chews the feed to help the digestion of the pet.

Also, according to the present invention, the separation prevention plate may be provided to prevent the feed separated from the throwing container from being separated to the outside of the device for throwing the feed.

### BRIEF DESCRIPTION OF THE DRAWINGS

FIG. 1 is a perspective view of an apparatus for supplying a feed according to the present invention.

FIG. 2 is a front view of the apparatus for supplying the feed according to the present invention.

FIG. 3 is a side view of the apparatus for supplying the feed according to the present invention.

FIG. 4 is a perspective view of a device for supplying a pellet according to the present invention.

FIG. 5 is an exploded perspective view of the device for supplying the pellet according to the present invention.

FIG. 6 is a side view of the device for supplying the pellet according to the present invention.

FIG. 7 is a perspective view of a main body constituting the device for supplying the pellet according to the present invention.

FIG. 8 is a perspective view illustrating a state in which a feed storage part is coupled to the apparatus for supplying the feed according to the present invention.

FIG. 9 is a front view of a pusher part constituting the device for supplying the pellet according to the present invention.

FIG. 10 is a front view a pusher part constituting the device for supplying the pellet according to another embodiment of the present invention.

FIG. 10 is a front view a pusher part constituting the device for supplying the pellet according to further another embodiment of the present invention.

FIG. 12 is a perspective view of a rotation plate constituting the device for supplying the pellet according to the present invention.

FIG. 13 is a perspective view of a device for throwing the feed at a seating position according to the present invention.

FIG. 14 is a perspective view of the device for throwing the feed at a throwing position according to the present invention.

FIG. 15 is a side view of the device for throwing the feed at the seating position according to the present invention.

FIG. 16 is a side view of the device for throwing the feed at the throwing position according to the present invention.

FIG. 17 is a perspective view of an elastic driving part constituting the device for throwing the feed according to the present invention.

FIG. 18 is a schematic view of the device for throwing the feed at the seating position according to the present invention.

FIG. 19 is a schematic view illustrating a state in which an elastic member is tensioned from the state of FIG. 18.

FIG. 20 is a schematic view illustrating a state in which a hook member is separated from the state of FIG. 18 to allow a throw part to rotate to the throwing position.

FIG. 21 is a perspective view of a hook part at the seating position of the throw part according to the present invention.

FIG. 22 is a perspective view of the hook part at the throwing position of the throw part according to the present invention.

FIG. 23 is a perspective view of a feed powder accommodation part according to the present invention.

FIG. 24 is a perspective view of a separation prevention plate according to the present invention.

### DESCRIPTION OF THE CODE ON THE MAIN PART OF THE DRAWING

100: Device for supplying pellet
110: Body part
120: Rotation plate part
130: Rotation plate driving part
140: Detection sensor
200: Device for throwing feed
210: Throw part
220: Fixing support part
230: Elastic driving part
240: Hook part
250: Stopper
260: Feed powder accommodation part
300: Rotation driving device
10: Case part
20: Camera part
30: Guide part
40: Separation prevention plate

### MODE FOR CARRYING OUT THE INVENTION

Hereinafter, embodiments of the present invention will be described with reference to the accompanying drawings.

In a device for supplying a pellet and an apparatus for supplying a feed using the same according to the present invention, a feed having the form of a pellet may be supplied in the form of the pellet so that a pet chews the feed one by one to help digestion.

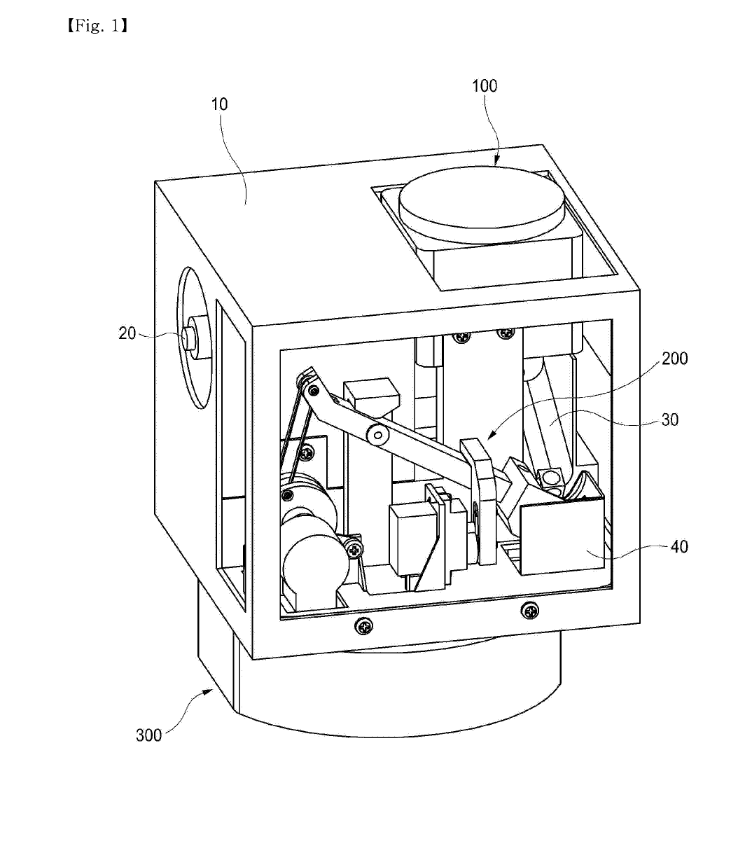

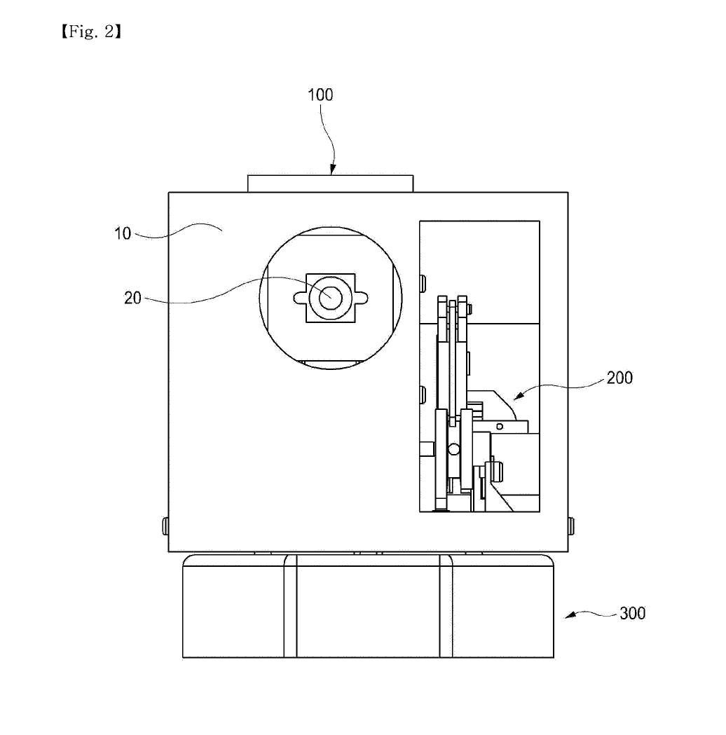

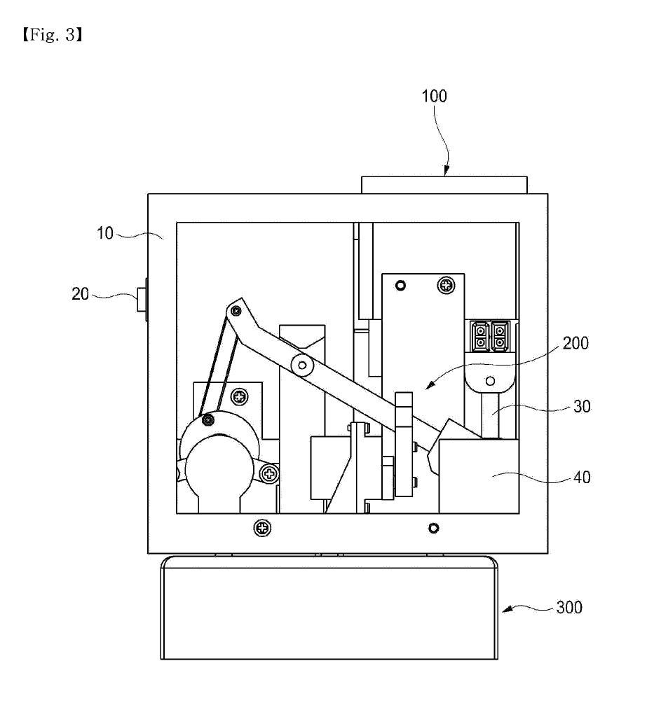

As illustrated in FIGS. 1 to 3, the apparatus for supplying a feed using a device for throwing a feed according to the present invention includes a device 100 for supplying a pellet, a device 200 for throwing the feed, and a rotation driving device 300.

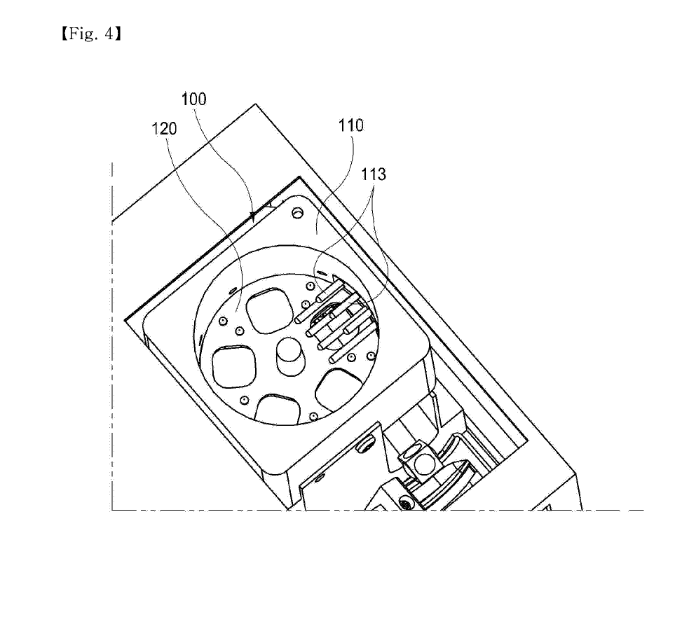

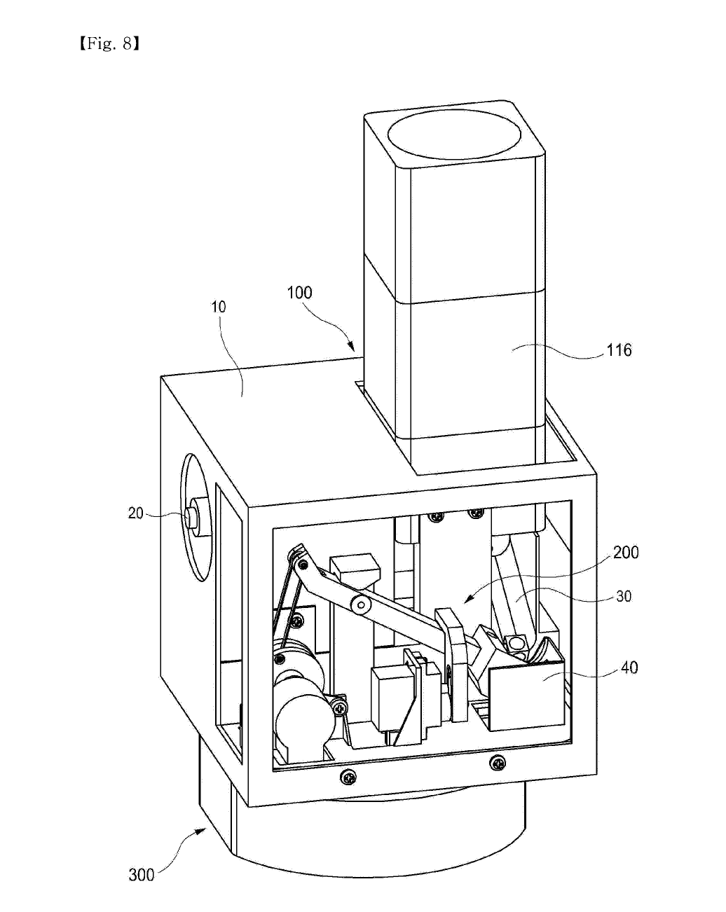

As illustrated in FIGS. 4 to 12, the device 100 for supplying the pellet includes a body part 110, a rotation plate part 120, a rotation plate driving part 130, a detection sensor 140, and a controller.

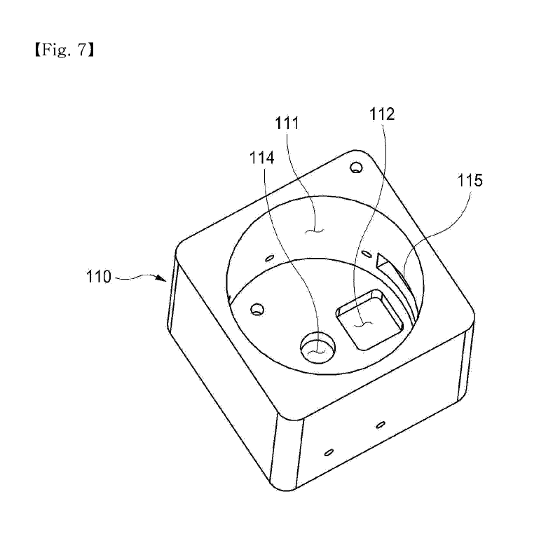

As illustrated in FIG. 7, the body part 110 is provided with an inner space 111 in which the pellet feeds are stored. A fixed hole 112, a rotation plate driving part insertion hole 114, and a pusher part arrangement plate insertion hole 115 are provided in the inner space 111.

The fixed hole 112 is formed in a position that is eccentric from a center of a bottom surface of the inner space 111 so that the feed is discharged from the inner space 111 to the outside of the body part 110 through the fixed hole 112.

The rotation plate driving part insertion hole 114 is formed in the center of the bottom surface of the inner space 111 and connects the rotation plate driving part 140 disposed outside the body part 110 to the rotation plate part 120 disposed inside the body part 110 to transmit a rotation driving force.

The pusher part disposition plate insertion hole 115 is formed in a side surface of the inner space 111 in a direction in which the fixed hole 112 is formed from the center of the inner space 111, and a pusher part arrangement plate 113e that will be described below is inserted into the pusher part arrangement plate insertion hole 115 and then coupled to the body part 110.

The body part 110 may include a feed storage part 116 and a pusher part 113.

The feed storage part 116 is formed on an upper portion of the body part 110 to extend and coupled to an upper portion of the inner space 111 to expand a feed storage capacity. Thus, the feed storage part 116 may be additionally provided according to an amount of feed consumed by the pet to increase the feed storage capacity, or the feed storage part 116 may be removed to reduce a volume of the apparatus for supplying the feed. Here, the number of feed storage parts 116 may be adjusted to set a feed storage capacity.

The pusher part 113 is provided on an upper portion of the fixed hole 112. One feed is discharged through the fixed hole 112, and introduction of the rest of feeds to the discharge position is prevented. Here, the discharge position refers to a position at which the rotation hole 121 and the fixed hole 112, which are formed in the rotation plate part 120, meet each other, i.e., a position through which the feed seated in the rotation hole 121 is discharged through the fixed hole 112.

Particularly, the feed seated in the rotation hole 121 formed in the rotation plate part 120 is discharged to the outside of the body part 110 through the fixed hole 112 when the rotation plate part 120 rotates to reach the discharge position. Here, the pusher part 113 introduces only one feed seated in the rotation hole 121 to the discharge position and blocks the introduction of the rest of feeds. Thus, the feeds may be provided in the form of the pellets.

The pusher part 113 is made of an elastic material, for example, made of a soft silicon material. Thus, the pusher part 113 may flexibly contact the feeds while blocking the rest of feeds to prevent the feeds from being introduced into the discharge position without damaging the feeds.

The pusher part 113 may be disposed in various shapes. A height from the bottom surface of the inner space 111 to a lower end of the pusher part 113 is greater than a maximum width of the feed and less than twice the maximum width of the feed. Thus, only one feed is introduced to the discharge position, and the rest of feeds are caught by the pusher part and thus blocked in introduction.

First, the pusher part 113 basically includes a pusher part arrangement plate 113e. The introduction of the feeds are blocked by at least one of a lower pin, an upper pin, and a protrusion plate, which protrude from the pusher part arrangement plate 113e.

The pusher part arrangement plate 113e is inserted into and fixed to the pusher part arrangement plate insertion hole 115 of the body part 110. Although not shown, the pusher part arrangement plate 113e may not be separately provided but be formed to allow at least one of the lower pin, the upper pie, and the protrusion plate to protrude from an inner surface of the body part 110.

Two or more lower pins 113a are disposed. Here, the lower pins 113a are disposed in lateral directions, respectively.

The upper pins may be disposed to be spaced apart from each other above the lower pin 113a and divided into first and second upper pins 113b and 113c.

The first upper pin 113b is disposed vertically above at least one of the lower pins 113a, and the second upper pin 113c is disposed between the two lower pins 113c adjacent to each other.

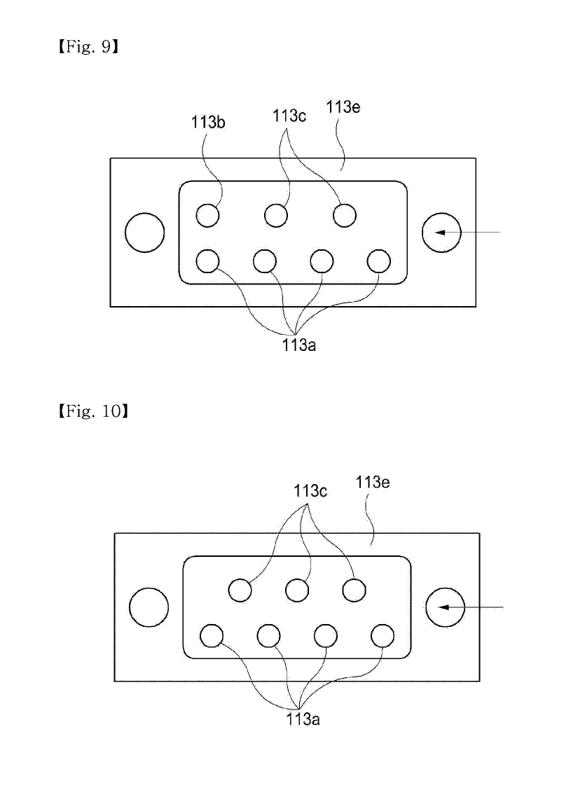

Hereinafter, the pusher part disposed in three shapes will be described in detail with reference to FIGS. 9 to 11. Here, an arrow expressed in the drawings represents a moving direction of the feeds due to the rotation of the rotation plate part 120.

First, as illustrated in FIG. 9, the pusher part 113 includes the first upper pin 113b and the second upper pin 113c.

Four lower pins 113a are disposed in lateral directions, respectively. A distance between the adjacent two lower pins 113a is less than a minimum width of the feed. Thus, the rest of feeds, which are blocked in introduction into the discharge position, may move to the upper portion of the pusher part 113 to prevent the feeds from being introduced into the discharge position by falling between the lower pins 113a.

The first upper pin 113b is disposed vertically above the lower pin 113a that is disposed at a first left side in the drawing. Here, the first upper pin 113b is disposed so that a distance between the upper pin 113b and the lower pin 113a that is disposed at the first position is less than the minimum width of the feed. Thus, the feeds, which are blocked in introduction into the discharge position, may move to the upper portion of the pusher part 113 to prevent the feeds from being introduced into the discharge position by falling between the lower pins 113a.

The first upper pin 113b may be disposed vertically above any lower pin 113a.

The second upper pins 113c may be disposed between the lower pins 113a that are disposed at second and third positions and between the lower pins 113a that are disposed at third and fourth positions in the drawing.

Second, as illustrated in FIG. 10, the pusher part 113 includes a lower pin 113a having a pin shape and a second upper pin 113c.

Four lower pins 113a are disposed in lateral directions, respectively.

Total three second upper pins 113c are spaced upward from the lower pins 113a and are disposed one by one between the adjacent two lower pins 113a. The second upper pins 113c are disposed so that a distance between the second upper pin 113c and at least one of the adjacent two lower pins 113a is less than the minimum width of the feed. Thus, the feeds, which are blocked in introduction into the discharge position, may move to the upper portion of the pusher part 113 to prevent the feeds from being introduced into the discharge position by falling between the second upper pin 113c and the adjacent lower pins 113a.

Here, a distance between the adjacent two second upper pins 113c is less than the minimum width of the feed.

Third, as illustrated in FIG. 11, the pusher part 113 includes a lower pin 113a having a pin shape, a second upper pin 113c, and a protrusion plate 113d.

Three lower pins 113a are disposed in lateral directions, respectively.

The second upper pins 113c are spaced upward from the lower pins 113a, and total two second upper pins 113c are disposed one by one between the adjacent two lower pins 113a.

The second upper pins 113c are disposed so that a distance between the second upper pin 113c and at least one of the adjacent two lower pins 113a is less than the minimum width of the feed. Thus, the rest of feeds, which are blocked in introduction into the discharge position, may move to the upper portion of the pusher part 113 to prevent the feeds from being introduced into the discharge position by falling between the second upper pin 113c and the adjacent lower pin 113a.

The protrusion plate 113d is formed in the form of a plate, and a top surface of the protrusion plate 113d is disposed to be inclined upward in a direction in which the feed rotates. Thus, the rest of feeds, which are blocked in introduction into the discharge position, may easily move to the upper portion of the pusher part 113 to prevent the feeds from being introduced into the discharge position.

The pusher part 113 having the above-described three shapes may be disposed irrespective of the number of the lower pin, the first upper pin, the second upper pin, and the protrusion plate. Also, the pusher part 113 may be disposed in any shape as long as the rest of feeds is prevented from being introduced into the discharge position by falling through the pusher part 113, the pusher part 113.

When the upper pin (the first upper pin or the second upper pin) is provided in plurality, a distance between the adjacent two upper pins is less than the minimum width of the feed. This is done for preventing the rest of feeds from being jammed and stagnated between the two upper pins while the feeds move to the upper portion of the pusher part.

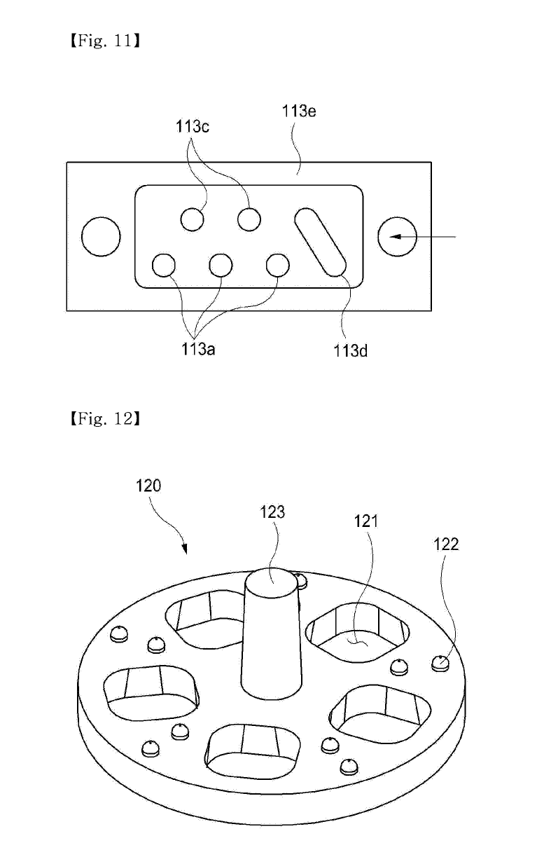

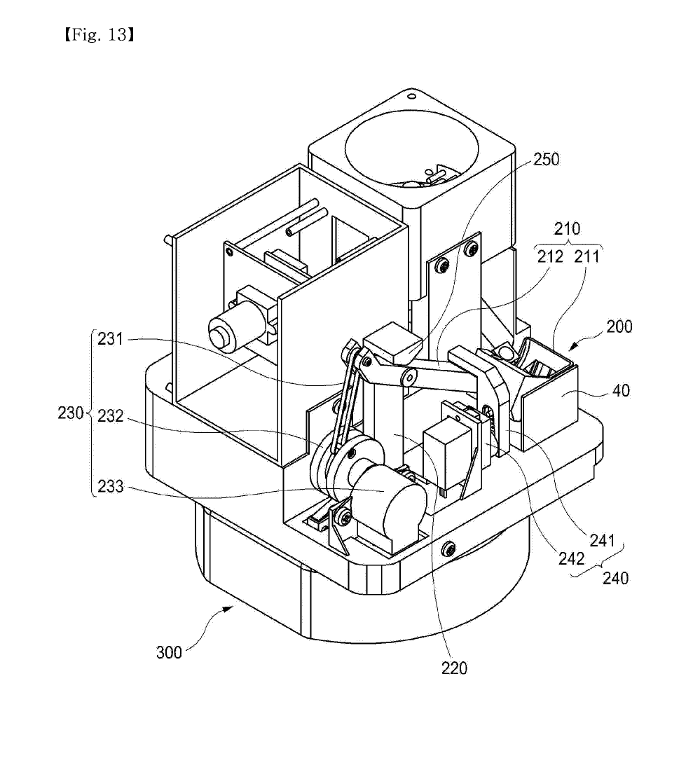

As illustrated in FIG. 12, the rotation plate part 120 is disposed in a lower portion of the inner space 111 to rotate and constituted by a rotation hole 121, a protrusion 122, and a central protrusion part 123.

The rotation hole 121 vertically passes through the rotation plate part 120, and one or more rotation holes 121 are formed. When the rotation plate part 120 rotates, the rotation hole 121 meets the fixed hole 112 to allow the feeds to be seated and move so that the feeds in the rotation hole 121 are discharged through the fixed hole 112.

The protrusion 122 protrudes from a top surface of the rotation plate 120. When the rotation plate part 120 rotates, the protrusion 122 stirs the feeds disposed on the upper portion of the rotation plate part 120 in the inner space 111. This is done for allowing the feeds to smoothly move in a vertical direction to prevent only the rotation plate part 120 from rotating due to the stagnation of the feeds in the inner space 111.

The central protrusion 123 protrudes from a rotational center of the top surface of the rotation plate 120. Thus, the feeds may be disposed to be eccentric from the center of the rotation plate part 120 so as to be rotatably movable. As a result, when the rotation plate part 120 rotates, the problem in which the feeds are disposed at the center of the rotation plate part 120 to rotate without movement may be prevented.

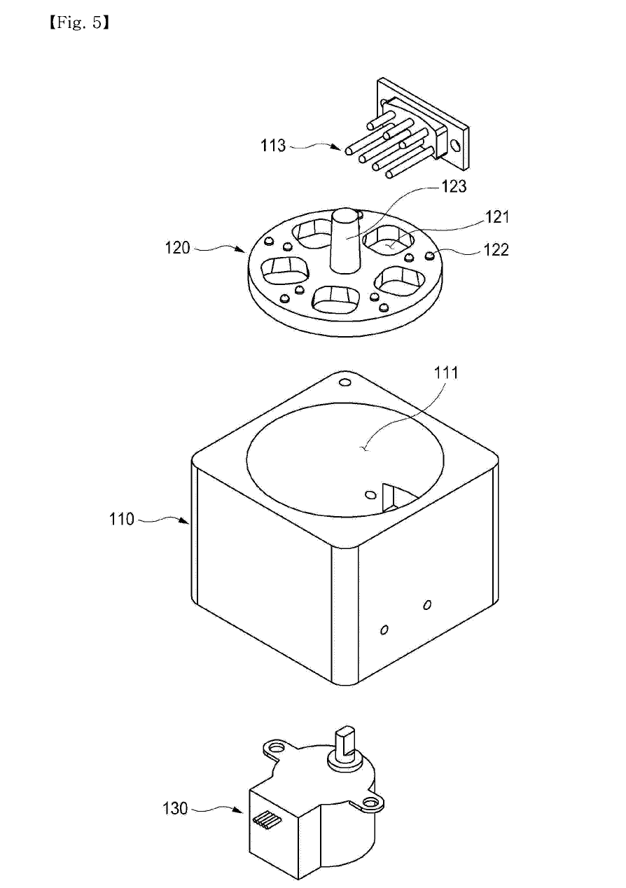

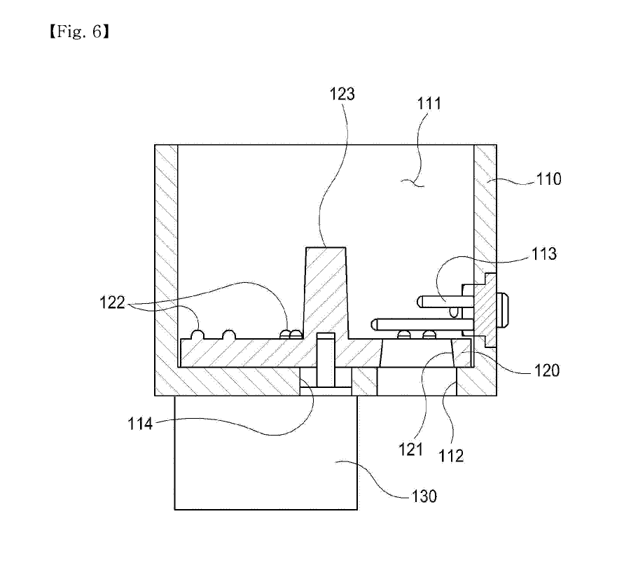

As illustrated in FIGS. 5 and 6, the rotation plate driving part 130 may be a driving member for rotating the rotation plate part 120. The rotation plate driving part 130 generates a rotational driving force and is connected to the rotation plate part 120 through the rotation plate driving part insertion hole 114. The rotation plate driving part 130 generates the rotational driving force to transmit the rotational driving force to the rotation plate part 120, thereby rotating the rotation plate part 120.

The detection sensor 140 is disposed in the fixed hole 112 to detect the feeds passing through the fixed hole 112. Thus, it is possible to grasp a problem such that the feeds are not supplied through the fixed hole 112, or a plurality of feeds are supplied.

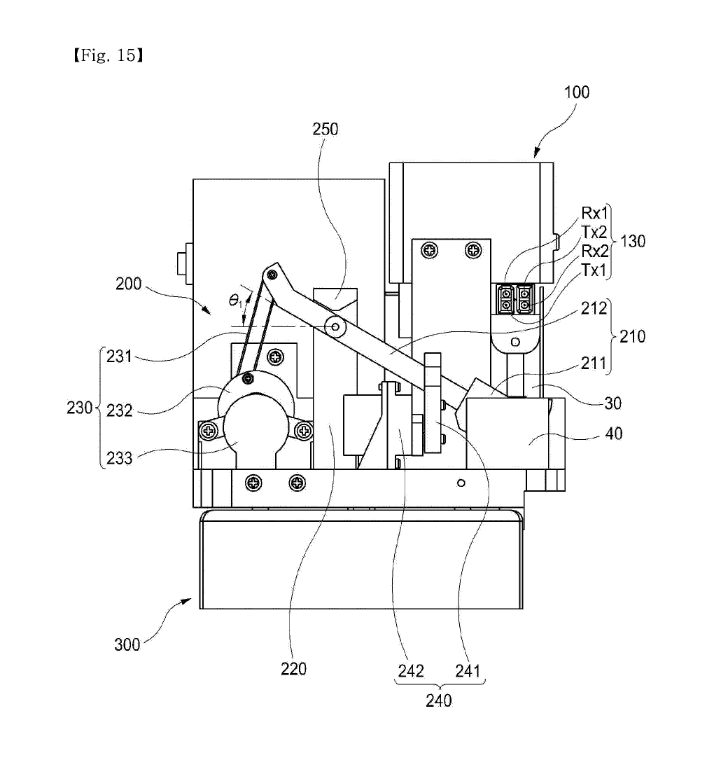

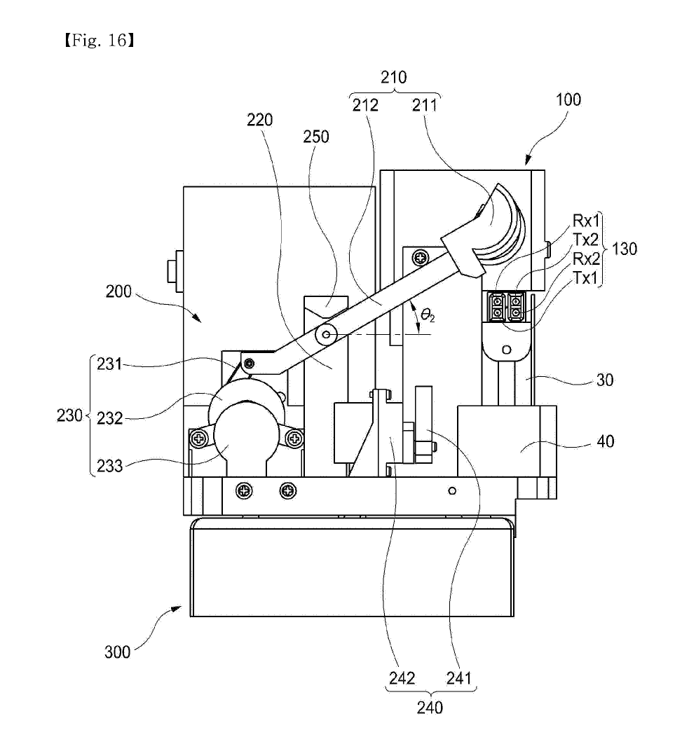

As illustrated in FIGS. 15 and 16, the detection sensor 140 may be constituted by a first light emitting part TX1, a first light receiving part RX1, a second light emitting part TX2, and a second light receiving part RX2.

The first light emitting part TX1 and the first light receiving part RX1 are vertically disposed in a pair. Light emitted from the first light emitting part TX1 may be reflected by the feeds and then received into the first light receiving part RX1 to detect whether the feeds are discharged.

The second light emitting part TX2 and the second light receiving part RX2 are vertically disposed in a pair. Light emitted from the second light emitting part TX2 may be reflected by the feeds and then received into the second light receiving part RX2 to detect whether the feeds are discharged.

Here, the second light emitting part TX2 and the second light receiving part RX2 may be disposed at side portions of the first light emitting part TX1 and the first light receiving part RX1. Thus, when compared that a pair of light emitting part and light receiving part are provided, the detection sensor may be improved in efficiency. Also, the first light emitting part TX1 may be disposed below the first light receiving part RX1, the second light emitting part TX2 may be disposed at the side portion of the first light receiving part RX1, and the second light receiving part RX2 may be disposed below the second light emitting part TX2. As described above, the light emitting part and the light receiving part are alternately disposed to more improve the efficiency of the sensor.

The controller controls an operation of the rotation plate driving part 130 according to whether the feeds are detected.

Particularly, the controller receives information with respect to whether the feeds are detected from the detection sensor 140. When the detection sensor 140 detects the feeds, the operation of the rotation plate driving part 130 is stopped to step the rotation of the rotation plate part 120. Thus, the pellet feed may be supplied through the fixed hole 112, and a sufficient time may be secured for supplying the next feed. Since the sufficient time is secured, it is possible to consider the time taken to throw the pellet feed by the device 200 for throwing the feed. In addition, the pet may sufficiently chew the feed to help the digestion.

Also, the controller may control the rotation plate part 120 to continuously rotate when the rotation hole 121 reaches the discharge position, but the feed is not detected. Also, when the plurality of feeds pass through the fixed hole 112, the controller informs that the supply of the pellet feed is abnormal.

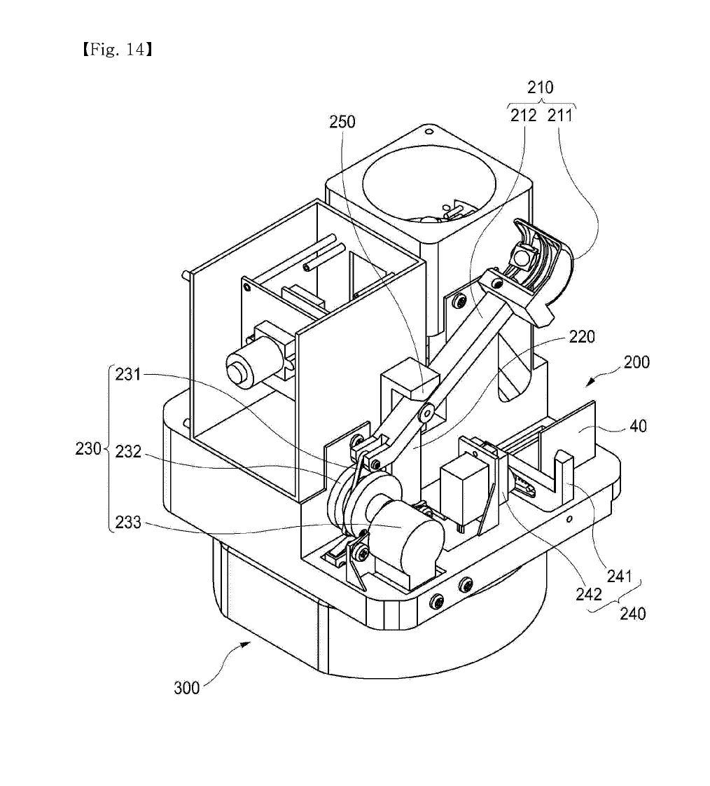

As illustrated in FIGS. 13 to 16, the device 200 for throwing the feed is a device for throwing the feeds discharged through the fixed hole 112 and includes a throw part 210, a fixing support part 220, an elastic driving part 230, a hook part 240, a stopper 250, and a feed powder accommodating part 260.

The throw part 210 throws the feeds supplied from the device for supplying the pellet and includes a throw container 211 and a throw arm 212.

The throw container 211 has a recessed bowl shape to allow the pellet feed discharged through the fixed hole 112 of the device for supplying the pellet to be seated. Here, the throw container 211 serves as a point of action of the throw part 210.

The throw arm 212 is a bar-shaped member coupled to the throw container 211 and rotates within a limited angle.

Here, the throw part 210 rotates between a seating position and a throwing position to throw the feed seated on the throw container 211. Here, the ‘seating position’ is in a state in which the throw container 211 is disposed at a lower side to seat the feed, and the ‘throwing position’ is in a state in which the throw container 211 is disposed at an upper side to apply a force to the feed and thereby to throw the feed from the seating position.

The fixing support part 220 is coupled to the rotational center of the throw part 210 to support the throw part 210. Thus, the throw part 210 may rotate with respect to the rotational center to throw the feed. Here, the rotational center serves as a support point of the throw part 210.

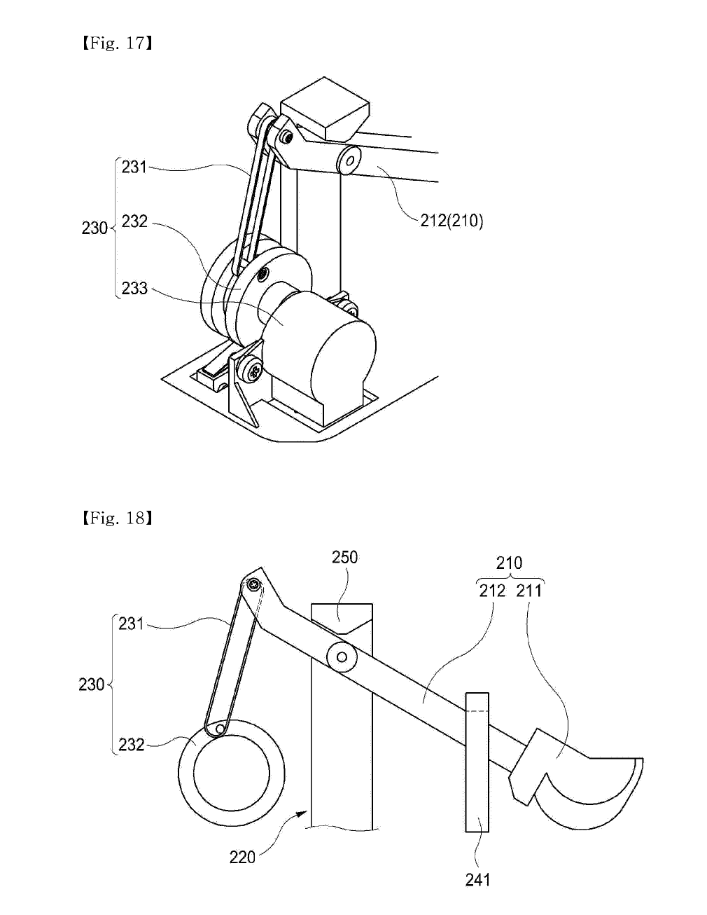

As illustrated in FIG. 17, the elastic driving part 230 rotates the throw container 211 between the seating position and the throwing position and includes an elastic member 231, a rotation drum 232, and a rotation driving source 233.

The elastic member 231 is made of an elastic material and thus tensioned to generate an elastic force. The elastic member 231 has one side connected to the throw arm 212 and the other side connected to the rotation drum 232. Here, a point at which the elastic member 231 and the throw arm 212 are connected to each other may be a force point of the throw part 210.

The rotation drum 232 is connected to the other side of the elastic member 231 to rotate. As the rotation drum 232 rotates, the elastic member 231 is wound around the outside of the rotation drum 232 and tensioned to generate an elastic force in the elastic member 231.

The rotation driving source 233 rotates the rotation drum 232 to provide the elastic force to the elastic member 231.

The elastic driving part 230 may further include a controller for controlling the rotation driving source 233 to adjust an amount of rotation of the rotation drum 232 and thereby to adjust a throwing distance of the feed.

The controller controls the rotation driving source 233 to adjust a rotation angle of the rotation drum 232 and adjusts a tensioned length of the elastic member 231 by changing the wound length of the elastic member 231 according to the rotation angle of the rotation drum 232. Thus, the elastic force generated in the elastic member 231 may be adjusted, and an intensity of the throwing of the feed may be adjusted to control the throwing distance of the feed.

Hereinafter, a process of driving the elastic driving part 230 will be described with reference to FIGS. 18 to 20.

FIG. 18 illustrates a state in which the throw part 210 is disposed at the seating position. The connected point of the throw arm 212 to which one side of the elastic member 231 is connected is disposed at an upper side, and the connected point of the rotation drum 232 to which the other side of the elastic member 231 is connected to is disposed to face the connected point of the throw arm 212. Here, the elastic member 231 is in a state in which the elastic member 231 is not tensioned and thus does not generate the elastic force.

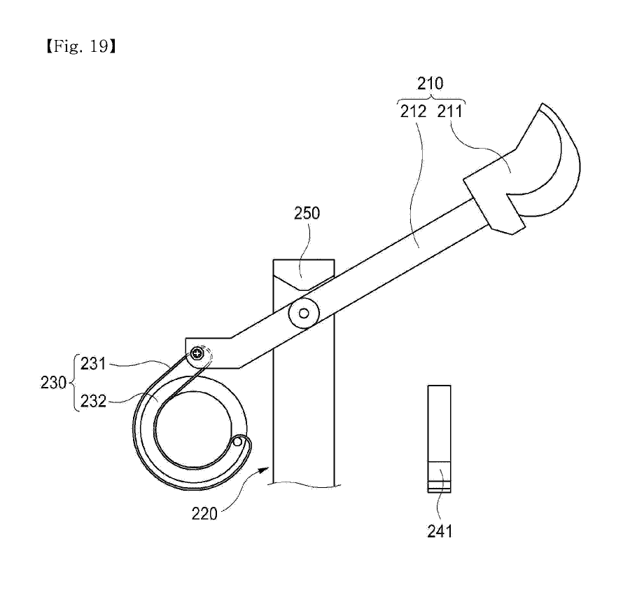

FIG. 19 illustrates a state in which the rotation drum 232 rotates to generate the rotation force. As the rotation drum 232 rotates, the connected point of the rotation drum 232 rotates to move in a counterclockwise direction in the drawing.

The throw arm 212 is in a state of being fixed at the seating position by the hook part 240. The connected point of the throw arm 212 is disposed at the upper side as ever, and the connected point of the rotation drum 232 rotates to move so that the other side of the elastic member 231 is wound around the outside of the rotation drum 232 and tensioned.

Thus, the elastic member 231 generates the elastic force through the tension.

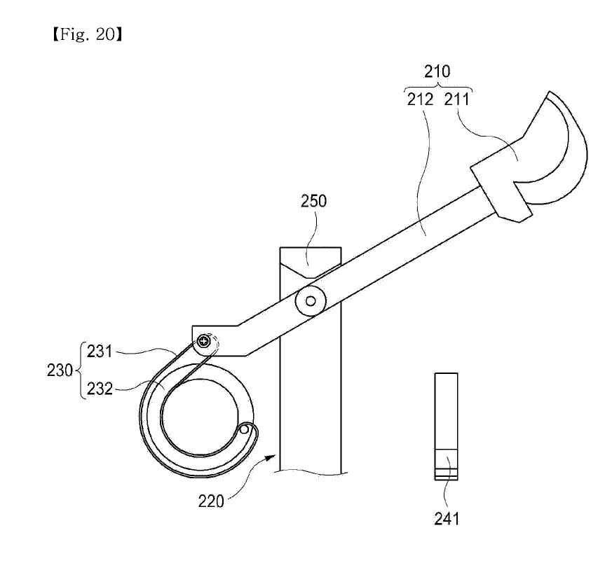

FIG. 20 illustrates a state in which the throw part 210 is disposed at the throwing position by the elastic force. The hook part 240 releases the state of the throw part 210, which is fixed to the seating position, and the connected point of the throw arm 212 moves toward the rotation drum 232 by the elastic force and is disposed at the lower side, and also, the connected point of the rotation drum 232 is disposed at the same position. Thus, the elastic member 231 allows the throw part 210 to be disposed at the throwing position by the elastic force and thereby to consume the elastic force.

Thereafter, when the connected point of the rotation drum 232 rotates to move in a clockwise direction in the drawing, the throw part 210 is disposed at the seating position by a load as illustrated in FIG. 18. Here, the elastic force is not generated in the elastic member 231.

The elastic driving part may have any structure as long as the throw part is capable of rotating from the seating position to the throwing position by the elastic force.

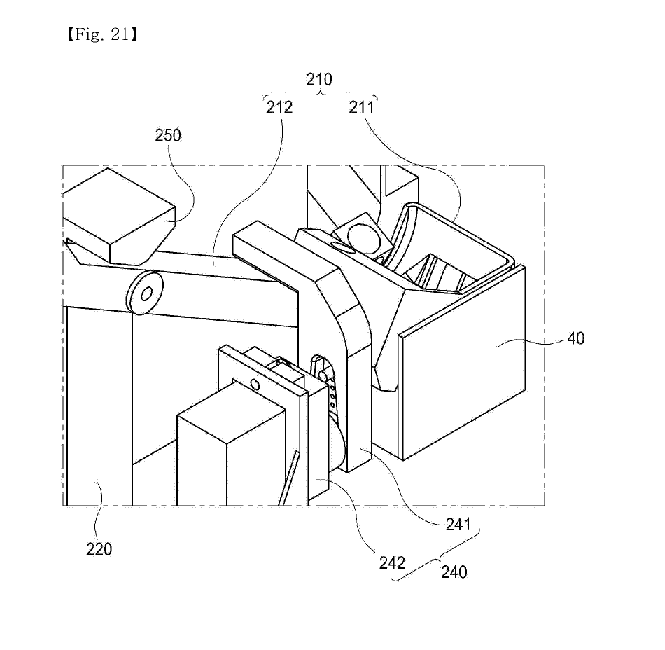

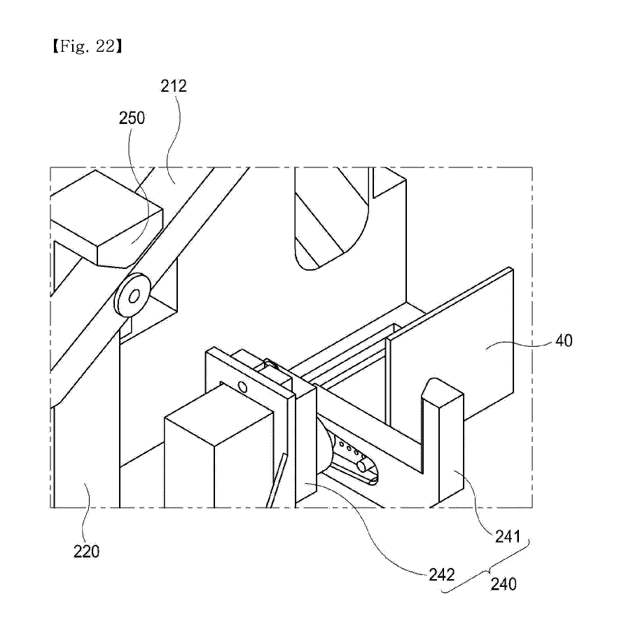

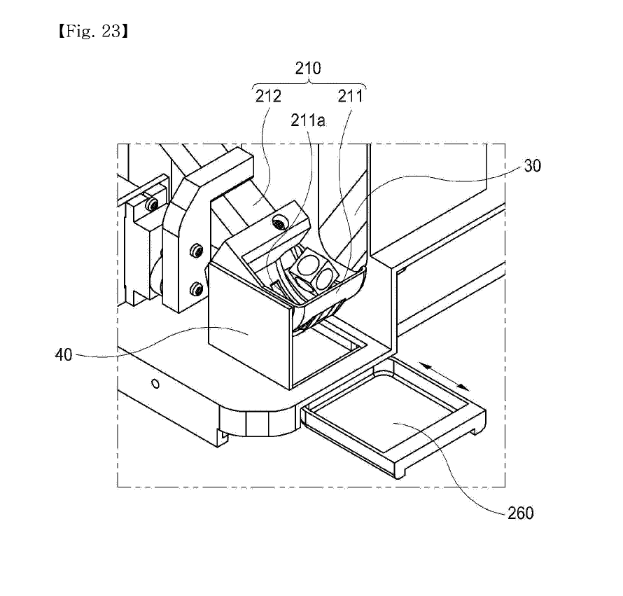

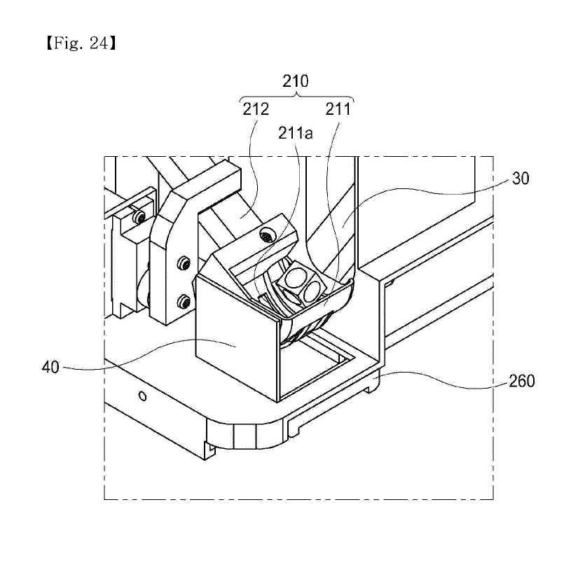

As illustrated in FIGS. 21 and 22, the hook part 240 is a support member that supports the seating position of the throw part 210 and includes a hook member 241 and a hook driving part 242.

The hook member 241 fixes the throw arm 212 at the seating position or releases the fixed state of the throw arm 212 so that the throw arm rotates from the seating position to the throwing position. Thus, in the state in which the elastic force is generated in the elastic member 231, the hook member 241 may fix the throw arm 212 so that the throw arm 212 is maintained at the seating position.

The hook driving part 242 moves between the position at which the throw arm 212 is fixed at the seating position and the position at which the fixed state of the throw part 212 is released to perform the locking and releasing functions.

Hereinafter, a process of driving the hook part 240 will be described with reference to FIGS. 21 and 22.

FIG. 21 illustrates a state in which the hook member 241 fixes the throw arm 212 at the seating position. The hook member 241 supports the throw arm 212, which is disposed between the rotational center and the throw container 211, from an upper side to maintain the seating position of the throw part 210. Thus, when the elastic force is generated toward the throwing position by the elastic driving part 230 at the seating position of the throw part 210, the throw arm is prevented from rotating to the throw position by the hook member 241.

FIG. 22 illustrates a state in which the hook member 241 releases the state in which the throw arm 212 is fixed to rotate from the seating position to the throwing position. The hook member 241 supporting an upper portion of the throw arm 212 rotates or moves. Thus, the supporting force of the hook member 241 with respect to the throw arm 212 may be released to allow the throw part 210 to rotate and move to the throwing position by the elastic force.

After the throw part 210 moves to the throwing position to throw the feed, the throw part 210 rotates and moves again to the seating position by the elastic driving part 230. In the state of moving to the seating position, the hook member 241 rotates or moves to an upper side of the throw arm 212 to maintain the seating position of the throw part 210.

The hook part 240 has a hook structure shape (for example, ‘¬’ shape) to rotate and move, thereby fixing the seating position of the throw arm 212 or releasing the fixed state of the throw arm 212. The hook part 240 may have any shape as long as the hook part 240 fixes the seating position of the throw arm 212 or releases the fixed state of the throw arm 212.

As illustrated in FIGS. 15 and 16, the stopper 250 limits the rotation angle of the throw arm 212 to set a seating position arrangement angle of the throw arm 212 and limits the rotation angle of the throw arm 212 at the throwing position to set a feed throwing angle.

The stopper 250 may be disposed above the fixing support part 220 and the throw part 210.

Particularly, referring to FIG. 15, the throw arm 212 is disposed at an inclined angle θ1 of 15° to 60° with respect to a horizontal plane at the seating position. When the inclined angle θ1 of the throw arm 212 is less than 15° at the seating position, an angle rotating to the throwing position is too small, and thus, it is difficult to generate a sufficient elastic force for throwing the feed. On the other hand, when the inclined angle θ1 of the throw arm 212 exceeds 60° at the seating position, the feed may not be seated on the throw container 211 to cause the falling.

Referring to FIG. 16, the throw arm 212 is disposed at an inclined angle θ2 of 15° to 60° with respect to the horizontal plane at the throwing position. Thus, the stopper 250 may set the feed throwing angle of the throw part 210. When the inclined angle θ2 of the throw arm 212 is less than 15° at the throwing position, an angle rotating to the throwing position is too small, and thus, it is difficult to generate a sufficient elastic force for throwing the feed. Also, a throwing angle of the feed is too large, and thus, the feed does not fly away and is thrown close to a vertical direction. On the other hand, when the inclined angle θ2 of the throw arm 212 exceeds 60° at the seating position, the throwing angle of the feed is too small, and thus, the feed is thrown close to a horizontal direction. Also, when the feed falls after being thrown, there is a problem that the feed is rolled from the falling point to enter into a lower side of furniture.

Thus, when the inclined angle θ2 of the throw arm 212 is set to 15° to 60°, more preferably, 20° to 50°, since the throwing angle of the feed is appropriate, a flying time of the feed is long, and the feed is not rolled when falling, and also, since the feed has a fly along a parabola, it is easy for the pet to catch the fly and eat the feed when the feed falls. The pet may also eat the flying feed before the feed falls.

Also, although not shown in the drawings, the stopper 250 may further include a stopper moving part.

The stopper moving part adjusts an arrangement position of the stopper so that the feed throwing angle is adjusted. Here, the arrangement angle of the throw arm may be adjusted by moving the position of the stopper to adjust the arrangement angle of the throw arm or by adjusting an inclined angle of a contact surface between the stopper and the throwing arm.

The stopper may have any shape as long as the arrangement angle of the throw arm is set at at least one position of the seating position and the throwing position.

A pellet stopper may be provided to limit the arrangement angle of the throw arm at each of the seating position and the throw position.

The feed powder accommodation part 260 may accommodate feed powder generated from the feeds to easily clean a feed throw place.

The throw container 211 has a discharge hole 211a in the bottom surface on which the feed is seated so that the powder generated while the feed is seated on the throw container 211 is discharged to the outside of the throw container 211 through the discharge hole 211a. Thus, the throw container 211 may throw only the feed to neatly maintain the surrounding or inside of the device for throwing the feed.

The feed powder accommodation part 260 is detachably disposed on a lower portion of the throw container 211 to accommodate the feed powder discharged from the discharge hole 211a of the throw container 211.

The feed powder accommodation part 260 may be slid in a drawer type and then detached from the device for throwing the feed.

Thus, when the feed powder is accommodated into the feed powder accommodation part 260, the feed powder accommodation part 260 is separated to process the feed powder, and then, the feed powder accommodation part 260 is mounted again. Thus, the inside of the device for throwing the feed may be easily cleaned.

The rotation driving device 300 is disposed below the device 200 for throwing the feed to rotate the device 200 for throwing the feed with respect to an axis perpendicular to the horizontal plane so that the throwing direction of the throw part 210 is adjusted. The rotation driving device 300 may rotate the whole of the device 100 for supplying the pellet and the device 200 for throwing the feed or parallelly rotate only the device 200 for throwing the feed.

Thus, the throwing direction of the feed may be adjusted. In addition, since the pet moves toward the feed that is thrown in various directions, a quantity of exercise of the pet may increase.

Also, the rotation driving device 300 may tilt the device 200 for throwing the feed with respect to the horizontal plane. Since the feed throwing angle varies, the throwing distance and the flying path of the feed may variously vary.

The rotation driving device 300 may include a base seated on the upper portion of the device 200 for throwing the feed and a base driving part rotatably driving the base. As illustrated in FIGS. 1 to 3, the apparatus for supplying the feed using the device for throwing the feed further includes a case part 10, a camera part 20, a guide part 30, a separation prevention plate 40, a sound source generation part, a communication part, and a controller.

The case part 10 is a member that covers the outsides of the device 100 for supplying the pellet and the device 200 for throwing the feed to protect the apparatus for supplying the feed. An outer appearance of the apparatus for supplying the feed may be elegant by the case part 10. Also, it is possible to prevent the pet or the user from interfering with the driving process of the device 200 for throwing the feed.

The case part 10 may have a hole or a switching part through which the feed is introduced into or discharged from the inner space 111 of the body part 110. Also, a hole through which the feed thrown from the device 200 for throwing the feed is thrown to the outside of the case part 10 may be formed in the case part 10. Also, a side surface of the case part 10 provided with the device for throwing the feed may be removed or provided as a transparent window so that the process of throwing the feed is visually inspected.

A camera for obtaining an image or a photograph is mounted on the camera part 20 in a direction in which the feed is thrown by the throw part 210.

Thus, even when the user is outgoing or in a space different from that of the apparatus for supplying the feed, the user may confirm where the food is thrown and how the pet feeds the thrown feed. Furthermore, the user may control the throwing distance and direction of the feed as the user instructs through a terminal by interlocking the terminal held by the user with the apparatus for supplying the feed or supply the feed by adjusting a time until the next feed is thrown after the feed is thrown.

The camera part 20 is driven to rotate by the rotation driving device 300 to obtain an image in the direction in which the feed is thrown.

The guide part 30 guides the feed so that the feed discharged through the fixed hole 112 of the device 100 for supplying the pellet is seated on the throw container 211 of the device 200 for throwing the feed.

The guide part 30 is preferably formed to be inclined downward from the lower portion of the fixed hole 112 and may have various shapes such as a straight line shape and a curved shape.

Here, the guide part 30 is formed so that the guide part 30 does not interfere with a path along which the throw part 210 rotates between the seating position and the throwing position.

The separation prevention plate 40 is a member having a plate shape, which is disposed at a side portion of the throw container 211 and prevents the feed separated from the throw container 211 from being separated to the outside of the apparatus for supplying the feed while the feed is supplied to the throw container 211 along the guide part 30.

The feed may be separated from the throw container 211 by the inclination of the guide part 30 and then be bounced to the side of the throw container 211. Here, the separation of the feed to the outside of the apparatus for supplying the feed may be prevented by the separation prevention plate 40, and the feed colliding with the separation prevention plate 40 may fall into the feed powder accommodation part 260 disposed below the throw container 211 and then reused.

The sound source generation part generates a sound source before the feed seated on the throw container 211 is thrown. Thus, the pet may listen to the sound source generated from the sound source generation part prepare for taking the feed by predicting the throwing time of the feed.

Also, the sound source generation part may generate the sound source between the throwing time point of the feed and the falling time point of the feed to allow the pet to be aware of the flying time of the feed.

Thus, since the pet is aware of the feed supply period through the sound source generated from the sound source generation part, the user may train the pet.

The communication part is a wired or wireless communication device that transmits the image information obtained from the camera part 20 to the user terminal and receives a throwing operation signal including at least one of a throwing direction signal, a throwing distance signal, and a throwing start signal.

The controller controls operations of the device 200 for throwing the feed and the rotation driving device 300 according to the throwing operation signal received by the communication part.

Thus, the user may supply the feed to the pet by operating the apparatus for supplying the feed through the image information displayed on the user terminal even through the user is distant from the pet and the apparatus for supplying the feed.

Also, since the user supplies the feed to the pet by determining the throwing direction, the throwing distance, the throwing time, and the like by using the user terminal, the user may feel a sense of fellowship with the pet. Also, the pet may eat the feed, which is supplied from the apparatus for supplying the feed, with fun through play to deteriorate psychological anxiety felt due to fear of being away from the user.

In terms of the process of supplying the feed to the pet according to the apparatus for supplying the feed, first, as the rotation plate part 120 of the device 100 for supplying the pellet rotates, the pellet feed is discharged through the fixed hole 112 at a point at which the feed seated in the rotation hole 121 meets the fixed hole 112.

The discharged feed is seated on the throw container 211 disposed at the seating position along the guide part 30. The elastic driving part 230 generates the elastic force by tensioning the elastic member 231 through the rotation of the rotation drum 232 in the throw part 210 is disposed at the seating position.

In the state in which the elastic member 231 generates the sufficient elastic force, and the feed is seated on the throw container 211, the hook member 241 rotates, and thus, the throw part 210 rotates to the throwing position by the elastic force.

The throw part 210 sets the throwing angle of the feed through the stopper 250.

After the feed is thrown, the elastic driving part 230 allows the rotation drum 232 to rotate in a reverse direction. Here, the elastic member 231 is not tensioned or contracted, and the throw part 210 rotates from the throwing position to the seating position.

When the throw part 210 is disposed at the seating position, the hook member 241 rotates again to fix the throw part 210 at the seating position and then waits for the next throw.

As described above, when the feed is supplied, the pet recognizes a route through which the feed is thrown to feel the fun and also reacts by a sound generated while the throw part is stopped at the throwing position by the stopper.

Also, the feed may be supplied in the form of the pellet to help the digestion of the pet by providing a sufficient time taken to chew and swallow the feed.

The device for throwing the feed may throw the set number, i.e., two or more feeds at the same time from the device 100 for supplying the pellet. For example, when a plurality of pets are present, the feeds may be supplied from the device 100 for supplying the pellet until the feeds are seated on the throw container 211 by the same number as that of pets, and then, the plurality of feeds seated on the throw container 211 may be thrown at the same time. As a result, the plurality of feeds are thrown in directions different from each other so that the plurality of pets respectively eat the feeds without fighting each other.

Although the specific embodiments of the present invention are described with reference to the accompanying drawings, it should be apparent that the scopes of the present invention affect equivalents and modifications within the technical spirit as set forth in the claims.

### INDUSTRIAL APPLICABILITY

The present invention provides the device for throwing the feed, which supplies the feed in the form of the pellet, and the apparatus for supplying the feed, which supplies the feed to the fat, using the same.

1. A device for throwing a feed, the device comprising:
a throw part comprising a throw arm rotating within a limited angle and a throw container coupled to the throw arm to allow the pellet feed to be seated thereon;
a fixing support part coupled to a rotational center of the throw arm to fix the throw part; and
an elastic driving part rotating between a seating position at which the feed is seated and a throwing position at which the feed is thrown.

2. The device of claim 1, wherein the elastic driving part comprises:
an elastic member made of an elastic material and having one side connected to the throw arm;
a rotation drum which is connected to the other side of the elastic member and around which the elastic member is wound; and
a rotation driving source rotating the rotation drum to provide an elastic force to the elastic member.

3. The device of claim 2, further comprising a controller controlling the rotation driving source to adjust a rotation amount of rotation drum so that a drawing distance of the feed is adjusted.

4. The device of claim 1, further comprising a hook part comprising a hook member fixing the throw arm at the seating position or releasing the fixed state so that the throw arm rotates from the seating position to the throwing position and a hook driving part driving the hook member.

5. The device of claim 1, further comprising a stopper restricting a rotation angle of the throw arm to set a throwing angle of the feed at the throwing position.

6. The device of claim 5, wherein, in the stopper, the throw arm is disposed to be inclined at an angle of 15° to 60° with respect to a horizontal plane at the throwing position.

7. The device of claim 5, further comprising a stopper moving part adjusting an arrangement position of the stopper to adjust a throwing angle of the feed.

8. The device of claim 1, wherein the throw container has a discharge hole, through which feed powder generated from the feed is discharged, in a bottom surface on which the feed is seated.

9. The device of claim 8, further comprising a feed powder accommodation part detachably disposed on a lower portion of the throw container to accommodate the feed powder.

10. The device of claim 1, further comprising a rotation driving device rotating the device for throwing the feed with respect to an axis perpendicular to a horizontal plane to adjust a throwing direction of the throw part.

11. The device of claim 10, wherein the rotation driving device tilts the device for throwing the feed with respect to the horizontal plane.

12. The device of claim 10, wherein the rotation driving device comprises:
a base on which the device for throwing the feed is seated on an upper portion thereof; and
a base driving part rotatably driving the base.

13. An apparatus for supplying a feed, the apparatus comprising:
the device for throwing the feed of claim 1;
a rotation driving device rotating the device for throwing the feed with respect to an axis perpendicular to a horizontal plane to adjust a throwing direction of the throw part;
a camera part rotatably driven by the rotation driving device to obtain an image in a direction in which the feed is thrown;
a wired or wireless communication part that transmits the image information to a user terminal and receives a throwing operation signal comprising at least one of a throwing direction signal, a throwing distance signal, and a throwing start signal from the user terminal; and
a controller controlling operations of the device for throwing the feed and the rotation driving device according to the throwing operation signal received from the communication part.

14. An apparatus for supplying a feed, which throws the feed having the form of a pellet, the apparatus comprising:
the device for throwing the feed of claim 1; and
a device for supplying a pellet, which supplies the pellet feed to the throw container.

15. The apparatus of claim 14, wherein the device for throwing the feed receives the set number of feeds, i.e., two or more feeds from the device for supplying the pellet to throw the feeds at the same time.

16. The apparatus of claim 14, wherein the device for supplying the pellet comprises:
a body part having a fixed hole, through which the feed is discharged, in a bottom surface of an inner space in which the feed is stored;
a rotation plate part disposed in the inner space and having one or more rotation holes, the rotation plate part rotating so that, when the rotation holes rotate, the feed seated in each of the rotation holes is discharged through the fixed hole from a discharge position at which the rotation hole and the fixed hole meet each other; and
a rotation plate driving part rotating the rotation plate part,
wherein the apparatus further comprises a guide part guiding the feed discharged through the fixed hole so that the feed is seated on the throw container.

17. The apparatus of claim 16, further comprising a separation prevention plate disposed at a side portion of the throw container to prevent the feed supplied to the throw container from being separated to the outside of the apparatus for supplying the feed.

18. The apparatus of claim 14, further comprising a sound source generation part generating a sound source before the feed seated on the throw container is thrown.

19. The apparatus of claim 18, wherein the sound source generation part generates the sound source between a throwing time point of the feed and a falling time point of the feed.
